(19) United States
(12) Patent Application Publication
(10) Pub. No.: US 2009/0296971 A1
(43) Pub. Date: Dec. 3, 2009

(54) Hearing Instrument Receiver With Improved Low-Frequency Efficiency

(75) Inventors: Oleg Saltykov, Fairlawn, NJ (US); Fred McBagonluri, East Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Hearing Instruments, Inc., Piscataway, NJ (US)

(21) Appl. No.: 12/207,759

(22) Filed: Sep. 10, 2008

Related U.S. Application Data
(60) Provisional application No. 61/056,996, filed on May 29, 2008.

(51) Int. Cl. H04R 1/20

(52) U.S. Cl. 381/351

(57) ABSTRACT

The low frequency efficiency of a hearing instrument receiver can be improved by increasing the unoccupied rear volume. The receiver may be configured with one or more motor and diaphragm assemblies. The receiver may also be fabricated using multiple, conventional receivers with an added housing to create the increased, unoccupied rear volume.

### CROSS-REFERENCE TO RELATED APPLICATIONS

This application is related to and claims the benefit of commonly-owned U.S. Provisional Patent Application Ser. No. 61/056,996, filed May 29, 2008, incorporated herein by reference.

### BACKGROUND AND SUMMARY OF THE INVENTION

A conventional hearing instrument receiver has a motor that converts an input signal to mechanical energy that moves a diaphragm suspended within the receiver housing. The diaphragm divides the interior volume of the housing into volumes in front of and behind the diaphragm, i.e., the “front volume” and the “rear volume.” A receiver tube connected to the front volume conveys the sound pressure created by the movement of the diaphragm to the ear canal of the user.

The efficiency of a hearing instrument receiver in a region of frequencies below 3 kHz, e.g., 500-1500 Hz, can be improved by increasing the unoccupied portion of the rear volume relative to the front volume, and providing a port in the rear volume and connecting a second receiver tube to that port. The diameter and length of the second receiver tube are chosen to achieve resonance at the frequencies of interest.

The receiver may employ at least one, or two or more motor and diaphragm assemblies. This receiver may be used in open-fit hearing instruments, i.e., one where the ear canal is not occluded, as well as in other devices such as cellular telephones and earphones.

### BRIEF DESCRIPTION OF THE DRAWINGS

FIG. 1 is a cross-sectional drawing of a receiver with an increased unoccupied rear volume;

FIG. 2 is a cross-sectional drawing of the receiver of FIG. 1 with a second receiver tube located partially within the rear volume;

FIG. 3 is a cross-sectional drawing of a receiver with a subdivided rear volume;

FIGS. 4-7 are cross-sectional drawings of a receiver with two motors;

FIGS. 8-10 are cross-sectional drawings of a receiver with two motors and subdivided front and rear volumes; and

FIGS. 11-12 are cross-sectional drawings of a receiver with two motors, comprising individual single-motor receivers and an added housing rear volume.

### DESCRIPTION OF THE INVENTION

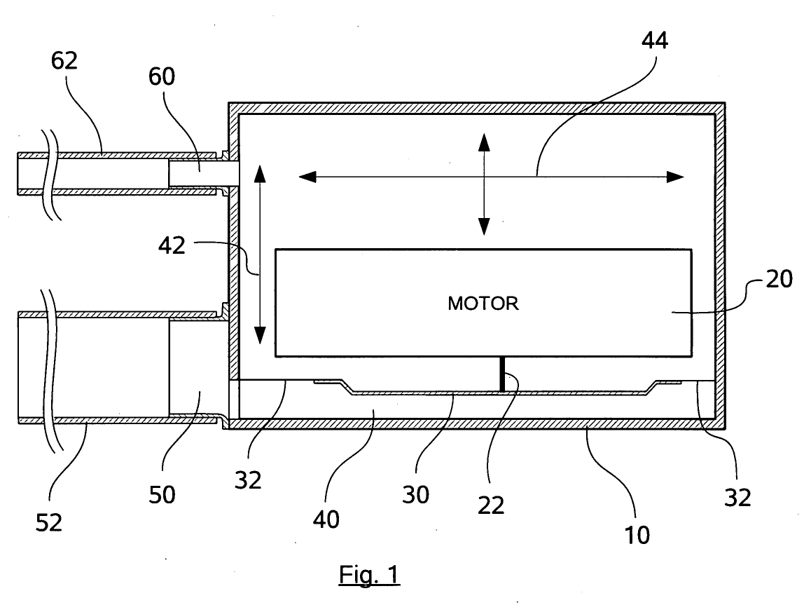

A hearing instrument receiver comprising a single motor is shown in FIG. 1. A suitable motor is the electromagnetic motor illustrated in U.S. Pat. No. 7,362,878, incorporated by reference herein, and comprises magnets, coils, and an armature. Alternatively, the receiver could employ a piezoelectric or an electrostatic motor, or a motor using some other technology.

A Receiver with an Increased Rear Volume

The receiver in FIG. 1 has a housing 10 which holds a motor 20. Although not illustrated in the figures, the motor 20 is rigidly supported within the housing 10 and would typically have electrical connections on the outside of the housing 10.

The motor 20 imparts force to a drive rod 22 that moves a diaphragm 30. The diaphragm 30 is supported within the housing 10 by a flexible support 32 such as a plastic film. One suitable material for the film is Mylar, a product of E. I. du Pont de Nemours and Company.

Together, the diaphragm 30 and the flexible support 32 divide the interior volume of the housing into two volumes: a front volume 40 and a rear volume 42. The rear volume 42 comprises the motor 20 and an unoccupied rear volume 44. A first output port or spout 50 connects the front volume 40 to a first receiver tube 52 and a second output port or spout 60 connects the rear volume 42 to a second receiver tube 62.

Acoustic Resonance of the Receiver

The unoccupied rear volume 44 and the second receiver tube 62 form an acoustic resonator, where the unoccupied rear volume 44 may be characterized as an acoustic compliance and the air in the second receiver tube 62 may be characterized as an acoustic mass. Since greater efficiency is sought in a band of low frequencies, i.e., below 3 kHz, the acoustic resonator (the unoccupied rear volume 44 of the receiver and the second receiver tube 62) are tuned for the center frequency of the desired band. Accordingly, the size of the unoccupied rear volume 44 relative to the front volume 40 and the length and inside diameter of the second receiver tube 62 are selected to achieve acoustic resonance at that center frequency.

The frequency of an acoustic resonator is governed by the following equation:

$$f = \frac{1}{2 π \sqrt{{M}_{A} \cdot {C}_{A}}}$$

where:

f is the frequency of the acoustic resonator;

M_{A} is the acoustic mass; and

C_{A} is the acoustic compliance.

(See, U.S. Pat. No. 5,261,006, incorporated herein by reference, col. 3, line 35, through col. 4 line 6.)

The product of acoustic mass and acoustic compliance can be determined given the desired center frequency. The necessary volume of the unoccupied rear volume 44 of the receiver and the dimensions of the second receiver tube 62 to achieve the product of acoustic mass and compliance that yields a center frequency of f may then be derived utilizing the formulas for acoustic compliance and mass. (See, e.g., Leo L. Beranek, “Acoustics,” pp. 128-33 (Acoustical Soc. of America 1954) (1986)). In practice, the unoccupied rear volume 44 may be sized to approximately six times the size of the front volume 40, and possibly fifteen to twenty times that volume.

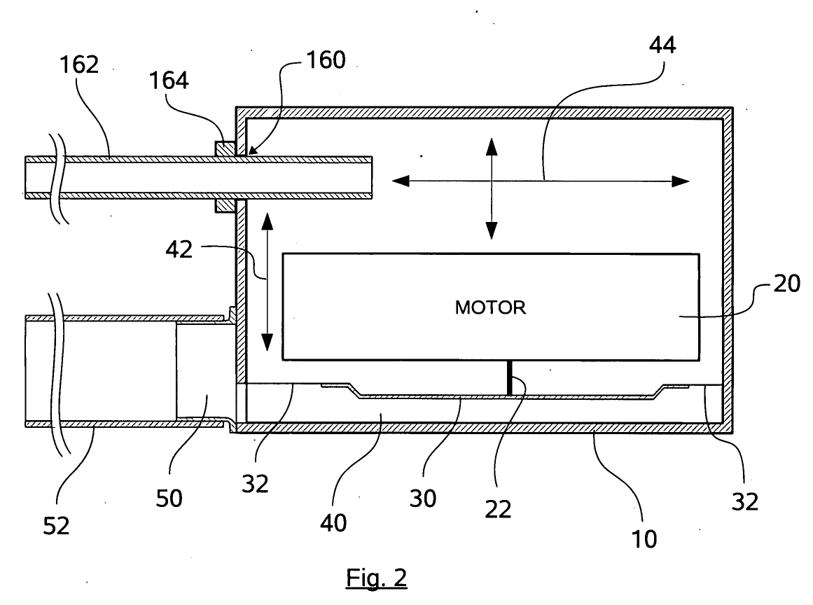

For example, the low frequency band of interest may be 500-1500 Hz and therefore the center frequency of that band would be 1000 Hz. Once the size of the unoccupied rear volume 44 is fixed, the acoustic compliance can be determined and this in turn will dictate the required acoustic mass to achieve acoustic resonance at 1000 Hz. The variables of length and inside diameter of the second receiver tube 62 are then chosen to provide the necessary acoustic mass. Typically, for a receiver employed in an open-fit hearing instrument and the size of its unoccupied rear volume, the inside diameter of the second receiver tube will be 0.5-2.0 mm and its length will be 5-20 mm.

Where space is at a premium and the required length of the second receiver tube exceeds the available space, the second receiver tube may be partially insert into rear volume. The receiver in FIG. 2 has a port 160 and a second receiver tube 162 partially located within the rear volume 42. A flange 164 may be provided for structural support for the second receiver tube 162 in this configuration.

A Receiver with a Subdivided Rear Volume

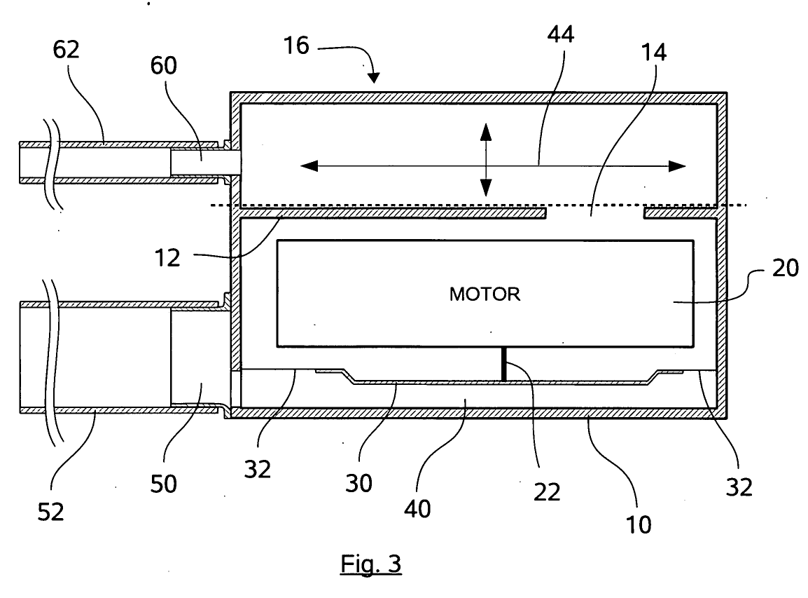

A second hearing instrument receiver comprising a single motor is shown in FIG. 3. In addition to the components described with respect to the receiver of FIG. 1, this device has a barrier or dividing wall 12 with a passageway 14, subdividing the rear volume 42. Such a configuration may be created by taking a conventional hearing instrument receiver and adding a separate housing 16 (the portion of the housing 10 above the dashed line). A passageway 14 or opening is then made in the conventional receiver housing to allow the sound pressure to travel into the separate housing 16.

Dual Motors

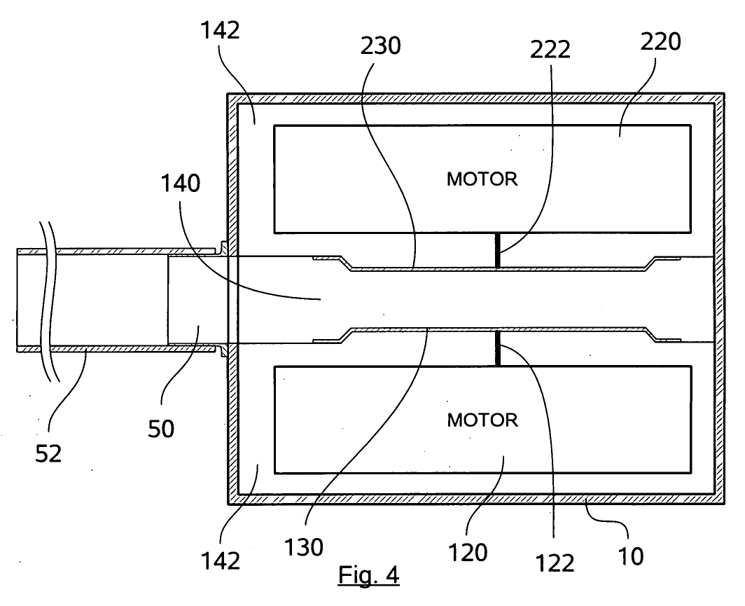

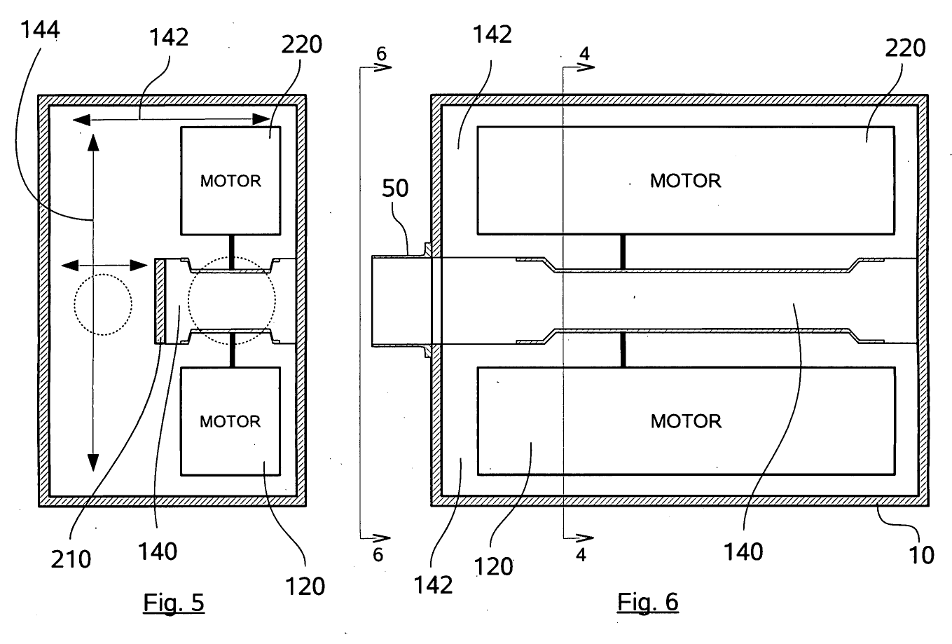

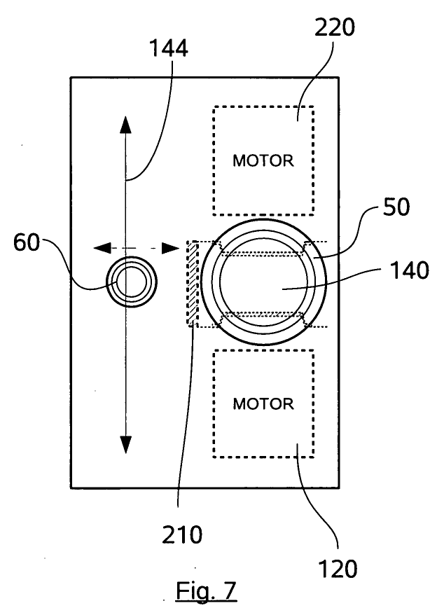

A receiver employing two motors 120 and 220 is shown in FIGS. 4-7. The motors 120 and 220 drive two diaphragms 130 and 230 with drive rods 122 and 222, respectively. The diaphragms 130 and 230 together with a barrier 210 delineate the front volume 140, while the rear volume 142 is behind the diaphragms 130 and 230 and the barrier 210. The unoccupied rear volume 144 can be seen in the cross-sectional end view of FIG. 5 and the external end view of FIG. 7.

In FIG. 4, the diaphragms 130 and 230 are positioned in opposition. Alternatively, the motors could be positioned side-by-side, with the two diaphragms in the same plane. Depending on the space available, the rear volume could be positioned above, below, around, or to the side of the motors.

Subdivided Front and Rear Volumes

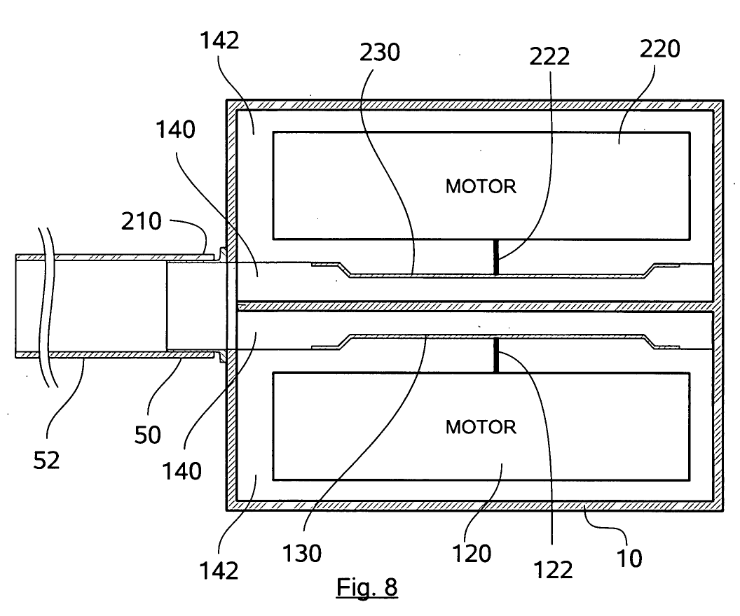

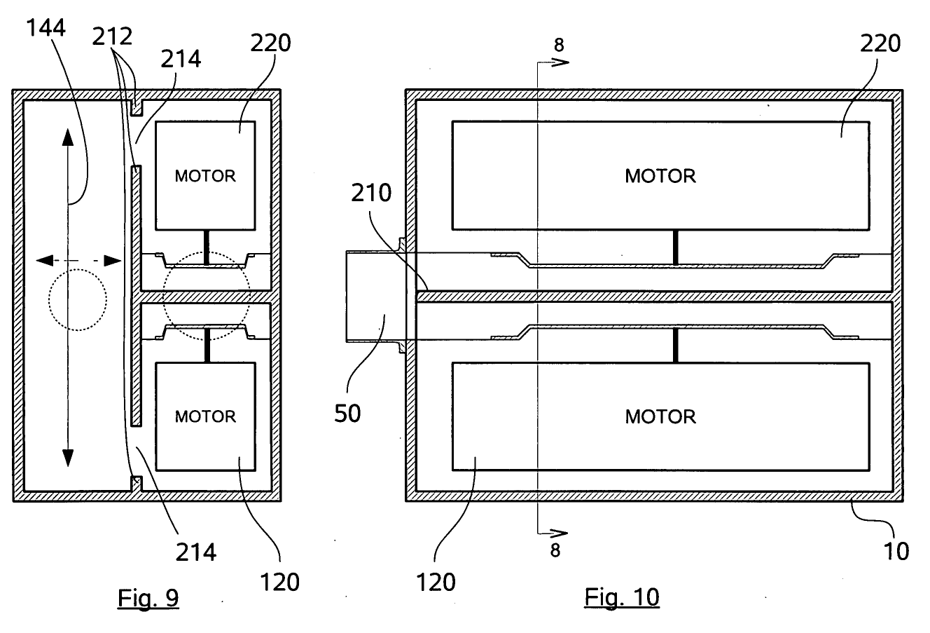

The receiver illustrated in FIGS. 8-10 employ barriers in the front and rear volumes 140 and 142. In FIG. 8, a horizontal barrier 210 between the diaphragms 130 and 230 subdivides the front volume 140. A vertical barrier 212, having passageways 214, subdivides the rear volume 142 creating an unoccupied rear volume 144. As desired, the receiver may use either or both of the horizontal and vertical barriers 210 and 212.

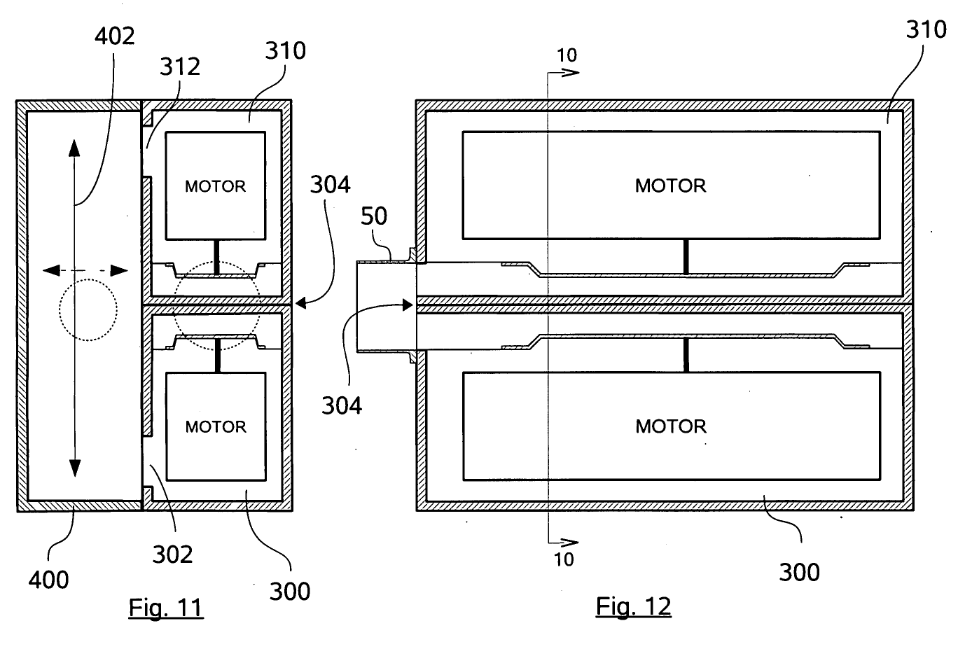

The receiver of FIGS. 8-10 may be fabricated from two conventional receivers 300 and 310, positioned together as shown in FIGS. 11 and 12. A housing 400 is attached to the two receivers 300 and 310 to create a rear volume 402. Passageways 302 and 312 are provided in the receivers 300 and 310, respectively, to allow the passage of sound.

What is claimed is:

1. A hearing instrument receiver, comprising:
a motor;
a diaphragm;
a housing, comprising an interior volume comprising the motor and the diaphragm, and a support for the diaphragm, where the diaphragm divides the interior volume into front and rear volumes, and the rear volume comprises an unoccupied rear volume, where the unoccupied rear volume is greater than the volume of the front volume;
a first receiver tube connected to the front volume; and
a second receiver tube connected to the rear volume.

2. A hearing instrument receiver as set forth in claim 1, where the unoccupied rear volume is at least six times the volume of the front volume.

3. A hearing instrument receiver as set forth in claim 1, further comprising a barrier subdividing the rear volume.

4. A hearing instrument receiver as set forth in claim 1, where the second receiver tube is positioned partially within the rear volume.

5. A hearing instrument receiver as set forth in claim 1, where the motor is an electromagnetic motor.

6. A hearing instrument receiver as set forth in claim 1, further comprising at least a second motor.

7. A hearing instrument receiver as set forth in claim 6, further comprising a barrier subdividing the front volume.

8. A hearing instrument receiver, comprising:
a motor;
a diaphragm;
a housing, comprising an interior volume containing the motor and the diaphragm, and a support for the diaphragm, where the diaphragm divides the interior volume into front and rear volumes, and the rear volume comprises an unoccupied rear volume;
a first receiver tube connected to the front volume; and
a second receiver tube connected to the rear volume;
where the unoccupied rear volume and the second receiver tube are acoustically resonant at a low frequency.

9. A hearing instrument receiver as set forth in claim 8, where the low frequency is less than 3 kHz.

10. A hearing instrument receiver as set forth in claim 8, where the unoccupied rear volume is at least six times the volume of the front volume.
